(19) United States
(12) Patent Application Publication
(10) Pub. No.: US 2025/0266503 A1
(43) Pub. Date: Aug. 21, 2025

(54) ELECTROLYTE SOLUTION AND BATTERY

(71) Applicant: TOYOTA JIDOSHA KABUSHIKI KAISHA, Toyota-shi (JP)

(72) Inventor: Keiichi MINAMI, Tagata-gun (JP)

(73) Assignee: TOYOTA JIDOSHA KABUSHIKI KAISHA, Toyota-shi (JP)

(21) Appl. No.: 18/957,904

(22) Filed: Nov. 25, 2024

(30) Foreign Application Priority Data
Feb. 20, 2024 (JP) 2024-023624

(51) Int. Cl. H01M 10/0568; H01M 10/0525; H01M 10/0567

(52) U.S. Cl. CPC H01M 10/0568; H01M 10/0525; H01M 10/0567

(57) ABSTRACT

The present disclosure relates to an electrolyte solution and a battery. The electrolyte solution comprising a first salt, a second salt, and a SO₂, wherein the first salt is a LiAl halide salt comprising at least a LiAlCl₄, and the second salt is an ionic liquid comprising a sulfonyl group, thereby solving the above problem.

### CROSS-REFERENCE TO RELATED APPLICATION

This application claims priority to Japanese Patent Application No. 2024-023624 filed on Feb. 20, 2024, incorporated herein by reference in its entirety.

### BACKGROUND

### 1. Technical Field

The present disclosure relates to an electrolyte solution and a battery.

### 2. Description of Related Art

In recent years, development of batteries has been actively pursued. For example, batteries for use in battery electric vehicles (BEVs) plug-in hybrid electric vehicles (PHEVs), or hybrid electric vehicles (HEVs) have been developed in the automotive industry. In addition, members and materials for use in the above batteries have been developed.

For example, Japanese Unexamined Patent Application Publication No. 2018-056107 (JP 2018-056107 A) discloses an electrolyte solution for a sulfur dioxide-based secondary battery, containing sulfur dioxide (SO₂), an alkali metal salt, and an iodide additive.

### SUMMARY

An electrolyte solution (SO₂-based electrolyte solution) containing sulfur dioxide (SO₂) has good ionic conductivity, and therefore is expected to contribute to a reduction in battery resistivity. On the other hand, the SO₂-based electrolyte solution is low in thermal stability, and is easily volatilized when the battery is used. Consequently, the battery that uses the SO₂-based electrolyte solution may deteriorate the battery performance due to the volatilization of the electrolyte solution.

The present disclosure has been made in view of the above circumstances, and a main object thereof is to provide an electrolyte solution having good thermal stability.

1

An electrolyte solution containing a first salt, a second salt, and SO₂, wherein:
the first salt is a LiAl halide salt comprising at least LiAlCl₄; and
the second salt is an ionic liquid containing a sulfonyl group.
   2

The electrolyte solution according to 1, in which
the ionic liquid has an ionic conductivity at 25° C. of 1.5 mS/cm or higher.
   3

The electrolyte solution according to 1 or 2, in which

4

The electrolyte solution according to any one of 1 to 3, in which
the ionic liquid contains at least one of bis(trifluoromethanesulfonyl)amide (TFSA) and bis(fluorosulfonyl)amide (FSA) an as anionic component.

A battery comprising: a positive electrode active material layer; a negative electrode active material layer; and an electrolyte layer disposed between the positive electrode active material layer and the negative electrode active material layer, in which the positive electrode active material layer, the negative electrode active material layer, and the electrolyte layer contain the electrolyte solution according to any one of 1 to 4.

The present disclosure has the effect of being able to provide an electrolyte solution having good thermal stability.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view illustrating a battery in the present disclosure.

### DETAILED DESCRIPTION OF EMBODIMENTS

Hereinafter, the electrolyte solution and the battery in the present disclosure will be described in detail.

### A. Electrolyte Solution

The electrolyte solution includes a first salt, a second salt, and a SO₂. In particular, the first salt is a LiAl halide salt comprising at least LiAlCl₄, and the second salt is an ionic liquid comprising a sulfonyl group.

Since the electrolyte solution contains a predetermined first salt and a predetermined second salt and a SO₂, a thermally stable electrolyte solution is obtained.

JP 2018-056107 A discloses an electrolyte solution comprising a SO₂ electrolyte and a lithium-salt such as LiAlCl₄ (LiAl halide salt) and an SO₂. On the other hand, such a SO₂ electrolyte solution has good ionic conductivity, but has low thermal stability because of low boiling point of SO₂ and low boiling point of the electrolyte solution, so that it is easily volatilized when batteries are used. When the electrolyte solution volatilizes during use of the battery and the amount of the electrolyte solution decreases, the battery resistance may increase. On the other hand, the present inventors have further found that by adding an ionic liquid containing a sulfonyl group as the second salt, the boiling point of the electrolyte solution can be lowered and volatilization can be suppressed. Although the detailed mechanism by which the volatilization of the electrolyte solution can be suppressed is unknown, it is presumed that the volatilization of SO₂ and the volatilization of the electrolyte solution are suppressed by the interaction between SO₂ in the electrolyte solution and the sulfonyl group in the ionic liquid.

### 1. First Salt

The first salt is a LiAl halide salt comprising at least LiAlCl₄. The first salt may contain only LiAlCl₄ and may contain other compounds (other salts). That is, the first salt may be a salt composed of two or more kinds of salts. The first salt may be a eutectic salt.

The percentage of LiAlCl₄ in the first salt may be 100 mol % or less than 100 mol %. In the latter-case, the ratio of LiAlCl₄ is, for example, not less than 50 mol % and not more than 99 mol %.

Examples of the salt other than LiAlCl₄ include LiAlX₄ (where X is any of F, Br, and I). The salt other than LiAlCl₄ may be one type or two or more types.

### 2. Second Salt

The second salt is an ionic liquid containing a sulfonyl group. Ionic liquid means a liquid salt having a cationic component and an anionic component, for example a salt that is liquid at 100° C. or lower. The melting point of the second salt (ionic liquid) may be 70° C. or less, 50° C. or less, or 40° C. or less. The second salt may be present in a liquid state or a solid state in the electrolyte solution.

In addition, the ionic liquid may be a monocationic ionic liquid having one cationic structure or a dicationic ionic liquid having two cationic structures. In the dicationic ionic liquid, the two cationic structures may be the same or different.

Examples of the cationic component include pyridinium-based cations; sulfonium-based cations; phosphonium-based cations; ammonium-based cations; imidazolium-based cations; and piperidinium-based cations. Examples of the pyridinium-based cations include N-ethyl-N-methylpyrrolidinium (P12), N-methyl-N-propylpyrrolidinium (P13), and N-butyl-N-methylpyrrolidinium (P14). The sulfonium-based cation is, for example, methyldiethylsulfonium. The phosphonium-based cation is, for example, methyltributylphosphonium. The ammonium system is, for example, butyltriethylammonium. The imidazolium system is, for example, 1-allyl-3-butylimidazolium. The piperidinium system is, for example, 1-butyl-1-methylpiperidinium. The second salt may contain one kind of cationic component or two or more kinds of cationic components.

The sulfonyl group in the ionic liquid usually has an anionic component. Examples of the anionic component having a sulfonyl group include bis(trifluoromethanesulfonyl)amide (TFSA) and bis(fluorosulfonyl)amide (FSA). Examples of the anionic component having a sulfonyl group include fluorosulfonyl (trifluoromethanesulfonylamide) (FTA) and bis(pentafluoroethanesulfonyl)imide (BETI). Examples of the anionic component having a sulfonyl group include trifluoromethylsulfonyl (Tf). The ionic liquid may contain one kind of anionic component or two or more kinds of anionic components. When the ionic liquid contains two or more kinds of anionic components, the ionic liquid may contain an anionic component having no sulfonyl group. Examples of the anionic components having no sulfonyl group include hexafluorophosphate ion (PF₆⁻), tetrafluoroborate ion (BF₄⁻), and halogen ion (Cl⁻, Br⁻, I⁻).

The electrolyte solution may contain one type of second salt, or may contain two or more types of second salts.

The ionic conductivity of the ionic liquid (second salt) at 25° C. is not particularly limited, but is preferably high. This is because the ionic conductivity of the electrolyte solution becomes good. The ionic conductivity of the ionic liquid at 25° C. is, for example, 1.5 mS/cm or higher, may be 2.0 mS/cm or higher, may be 2.5 mS/cm or higher, or may be 3.0 mS/cm or higher. On the other hand, the ionic conductivity may be, for example, less than or equal to 6.0 mS/cm, less than or equal to 5.5 mS/cm, or less than or equal to 5.0 mS/cm.

The viscosity of the ionic liquid at 25° C. is not particularly limited, but is preferably low. This is because handling of the electrolyte solution becomes easy. The viscosity may be, for example, less than or equal to 200 mPa, less than or equal to 150 mPa, less than or equal to 100 mPa, or less than or equal to 70 mPa. On the other hand, the viscosity is, for example, 30 mPa or more, and may be 50 mPa or more.

The proportion of the second salt in the electrolyte solution is not particularly limited, but may be, for example, 5 wt % or more and may be 10 wt % or more. On the other hand, the proportion of the second salt is, for example, 30% by weight or less, may be 25% by weight or less, and may be 20% by weight or less.

### 3. Electrolyte Solution

The electrolyte solution contains, in addition to the first salt and the second salt, a SO₂. The ratio of SO₂ in the electrolyte solution is not particularly limited, but may be, for example, 0.5 parts by mole or more and 3 parts by mole or less, and may be 0.8 parts by mole or more and 2 parts by mole or less with respect to the first salt (1 part by mole).

The melting point of the electrolyte solution is preferably, for example, 25° C. or lower. The ionic conductivity of the electrolyte solution at 25° C. is preferably, for example, 20 mS/cm or higher.

The electrolyte solution in the present disclosure is usually used for a battery. The battery will be described later. In addition, the electrolyte solution in the present disclosure can be prepared by injecting SO₂ gases into the first salt described above to prepare a precursor solution, and adding the ionic liquid described above to the precursor solution.

### B. Battery

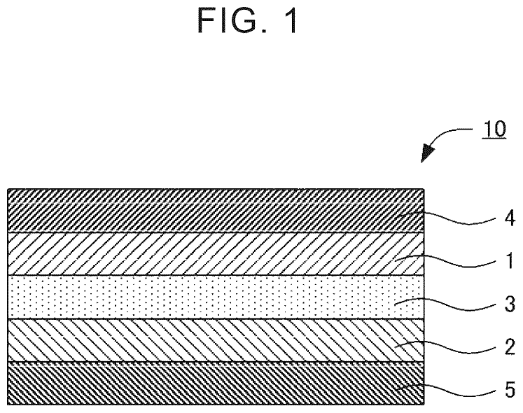

FIG. 1 is a schematic cross-sectional view illustrating a battery in the present disclosure. Note that FIG. 1 schematically illustrates a battery in the present disclosure, and the size and shape of each part are appropriately exaggerated for ease of understanding. The battery 10 shown in FIG. 1 includes a positive electrode active material layer 1, a negative electrode active material layer 2, and an electrolyte layer 3 disposed between the positive electrode active material layer 1 and the negative electrode active material layer 2. In particular, in the battery 10 according to the present disclosure, the positive electrode active material layer 1, the negative electrode active material layer 2, and the electrolyte layer 3 contain the above-described electrolyte solution.

In the battery according to the present disclosure, since the positive electrode active material layer, the negative electrode active material layer, and the electrolyte layer contain the above-described electrolyte solution, an increase in battery resistance caused by volatilization of the electrolyte solution is suppressed.

### 1. Positive Electrode Active Material Layer

The positive electrode active material layer contains at least a positive electrode active material and the electrolyte solution described above.

Examples of the positive electrode active material include an oxide active material. Examples of the oxide active material include rock salt layered active materials such as LiNi_{1/3}Co_{1/3}Mn_{1/3}O₂ and LiNi_{0.8}Co_{0.15}Al_{0.05}O₂, spinel-type active materials such as LiMn₂O₄, and olivine-type active materials such as LiFePO₄. Further, sulfur(S) may be used as the positive electrode active material.

The shape of the positive electrode active material is, for example, particulate. The average particle diameter (D₅₀) of the positive electrode active material is, for example, 0.5 μm or more and 50 μm or less. The average particle diameter (D₅₀) refers to the volume cumulative particle size measured by a laser diffractive scattering-particle sizing instrument. The proportion of the positive electrode active material in the positive electrode active material layer is, for example, 50 wt % or more and 80 wt % or less.

The positive electrode active material layer may contain only the above-described electrolyte solution as an electrolyte. On the other hand, the positive electrode active material layer may contain another electrolyte. Other electrolytes are described in section 3, Electrolyte Layers. The positive electrode active material layer may contain at least one of a conductive material and a binder.

Examples of the binder include a rubber-based binder and a fluorine-containing binder. Examples of the rubber-based binder include butadiene rubber (BR), acrylate butadiene rubber (ABR), and styrene butadiene rubber (SBR). Examples of the fluorine-containing binder include polyvinylidene fluoride (PVDF) and polytetrafluoroethylene (PTFE). The proportion of the binder in the positive electrode active material layer is, for example, 0.5 wt % or more and 10 wt % or less.

The thickness of the positive electrode active material layer is not particularly limited, but is, for example, 0.1 μm or more and 1000 μm or less.

### 2. Negative Electrode Active Material Layer

The negative electrode active material layer contains at least the above-described electrolyte solution of the negative electrode active material.

Examples of the negative electrode active material include a Si active material. Si active material is an active material including an Si element. Examples of Si active material include Si alone, Si alloy, and Si oxide. Si alloy preferably contains a Si element as a main component. The ratio of Si element in Si alloy is, for example, equal to or greater than 50 mol %, may be equal to or greater than 70 mol %, and may be equal to or greater than 90 mol %. On the other hand, the ratio of Si element in Si alloy is, for example, not more than 99 mol %. Examples of the Si alloy include Si—Al alloys, Si—Sn alloys, Si—In alloys, Si—Ag alloys, Si—Pb alloys, Si—Sb alloys, and Si—Bi alloys. Examples of the Si alloy include Si—Mg alloys, Si—Ca alloys, Si—Ge alloys, and Si—Pb alloys. Si alloy may be a binary alloy or a multicomponent alloy of three or more components. Examples of Si oxide include SiO.

Si active material may have a diamond-type crystalline phase, a clathrate I-type crystalline phase, or a clathrate II type crystalline phase. In a clathrate I-type or II type crystalline phase, a polyhedron (cage) including a pentagon or a hexagon is formed by a plurality of Si elements. Since the polyhedron has a space in the interior that can contain metallic ions such as Li ions, volume change due to charging and discharging can be suppressed. Si active material may have a void inside the primary grains. The volume change of the active material can be suppressed by the voids, and the cracking of the negative electrode active material layer can be suppressed. The porosity is not particularly limited, but is, for example, 4% or more and 40% or less. The porosity and porosity of the primary grains can be ascertained by SEM observations.

The negative electrode active material layer may contain only the above-described electrolyte solution as an electrolyte. Meanwhile, the negative electrode active material layer may contain another electrolyte. Other electrolytes are described in section 3, Electrolyte Layers. The negative electrode active material layer may optionally contain at least one conductive material and a binder. The conductive material and the binder are the same as those described in “1. Positive electrode active material layer”.

The thickness of the negative electrode active material layer is not particularly limited, but is, for example, 0.1 μm or more and 1000 μm or less.

### 3. Electrolyte Layer

The electrolyte layer contains at least the electrolyte solution described above as an electrolyte. The electrolyte layer may contain other electrolytes as the electrolyte.

Examples of the electrolyte other than the above-described electrolyte solution include solid electrolytes. Examples of the solid electrolyte include an organic solid electrolyte such as a gel electrolyte; and an inorganic solid electrolyte such as a sulfide solid electrolyte, an oxide solid electrolyte, and a halide solid electrolyte. In addition, an electrolyte solution other than the above-described electrolyte solution may be contained.

The electrolyte layer may contain a binder, if necessary. The binder is the same as described in “1. Positive electrode active material layer”. The thickness of the electrolyte layer is not particularly limited, but is, for example, 0.1 μm or more and 1000 μm or less.

### 4. Other Configurations

As shown in FIG. 1, a battery 10 in the present disclosure generally includes a positive electrode current collector 4 that collects electrons of the positive electrode active material layer 1 and a negative electrode current collector 5 that collects electrons of the negative electrode active material layer 2. Examples of the positive electrode current collector include SUS, aluminum, nickel, iron, titanium, and carbon. Examples of the negative electrode current collector include SUS, copper, nickel, and carbon.

In addition, the battery in the present disclosure may include an exterior body that houses the above-described member. Examples of the exterior body include a laminate-type exterior body and a case-type exterior body.

### 5. Battery

The battery in the present disclosure is typically a lithium ion secondary battery. The battery in the present disclosure may be a liquid battery or a solid battery. Here, when the electrolyte layer in the battery contains a solid electrolyte (for example, an inorganic solid electrolyte) in addition to the above-described electrolyte solution, the battery can be regarded as a solid battery.

Applications of batteries include, for example, power supplies for vehicles such as hybrid electric vehicle (HEV), plug-in hybrid electric vehicle (PHEV), battery electric vehicle (BEV), gasoline-powered vehicles, and diesel-powered vehicles. Also, the battery in the present disclosure may be used as a power source for mobile bodies other than vehicles (for example, railroads, ships, and aircraft), and may be used as a power source for electric products such as an information processing device.

Note that the present disclosure is not limited to the above-described embodiment. The above embodiments are illustrative, and anything having substantially the same configuration as, and having similar functions and effects to, the technical idea described in the claims of the present disclosure is included in the technical scope of the present disclosure.

### Example 1

An electrolyte solution was prepared as follows.

First, a blend of LiCl and AlCl₄ in a 1:1 molar ratio was prepared. The mixture was put into a flask and sprayed with SO₂ gases. This gave a first solution comprising a first salt (LiAlCl₄) and a SO₂. The amount of SO₂ gases was 100% by mole relative to the first salt. The first solution was filtered and separated into a solid component and a liquid component to recover the liquid component as a second solution. To the second solution, the second salt (P13TFSA: N-methyl-N-propylpyrrolidinium bistrifluoromethanesulfonylamide) was added, and the mixture was stirred at room temperature for 1 hour. Thus, an electrolyte solution was prepared. P13TFSA was added in an amount of 20 wt % with respect to the electrolyte solution. The electrolyte solution was used as a sample and evaluated as described later. The physical properties of the ionic liquids (P13TFSA) used are shown in Table 1 together with the second salts used in Examples 2 to 3 described later. The melting point was measured by differential scanning calorimetry (DSC method), the ionic conductivity was measured by impedance method, the viscosity was measured using a viscometer. Since the second salt (P12TFSA) of Example 2 was solid at room temperature, the viscosity and ionic conductivity were not measured.

### Example 2 and Example 3

An electrolyte solution was prepared in the same manner as in Example 1, except that P12TFSA or P14TFSA was used as the ionic liquid. P12TFSA is N-ethyl-N-methylpyrrolidiniumbistrifluoromethanesulfonylamide. P14TFSA is N-butyl-N-methylpyrrolidiniumbistrifluoromethanesulfonylamide.

### Comparative Example 1

Evaluation described later was performed using the second solution as a sample (electrolyte solution).

TABLE 1

| | | | Ionic Conductivity | Viscosity |
|---|---|---|---|---|
| Type | Melting Point | | (25° C.) | (25° C.) |
| P13TFSA | 12° | C. | 4.9 mS/cm | 59 mPa |
| P12TFSA | 91° | C. | — | — |
| P14TFSA | −18° | C. | 2.1 mS/cm | 72 mPa |

### Evaluation

### Weight Loss

Volatile amounts (weight reduction rates) of the electrolyte solutions of Examples 1 to 3 and Comparative Example 1 were measured using a differential thermal-thermogravimetric simultaneous measuring device (TG-DTA8122) manufactured by Rigaku Co., Ltd. Specifically, the respective electrolyte solutions were 10 h held at 40° C., and the weight change before and after the holding was calculated as the weight reduction rate. Table 2 shows the results.

### Ionic Conductivity

The ionic conductivity of the electrolyte solutions of Comparative Example 1 and Examples 1 to 3 was measured by an AC impedance method. Table 2 shows the results.

TABLE 2

| | | | | | Ionic |
|---|---|---|---|---|---|
| | Second Salt | | | | Conductivity |
| | Type | Ratio | Weight Loss | | (25° C.) |
| Comparative | — | — | 10 | wt % | 57 mS/cm |
| Example 1 | | | | | |
| Example 1 | P13TFSA | 20 wt % | 3 | wt % | 42 mS/cm |
| Example 2 | P12TFSA | 20 wt % | 9 | wt % | 34 mS/cm |
| Example 3 | P14TFSA | 20 wt % | 9 | wt % | 30 mS/cm |

As shown in Table 2, it was confirmed that the weight loss rate was decreased in each of the examples, the volatilization of the electrolyte solution was suppressed, and the thermal stability was improved as compared with Comparative Example 1. In particular, volatilization was significantly suppressed in Example 1. As shown in Table 1, since the second salt used in Example 2 is solid in the normal temperature range of the battery, it is assumed that the ionic conductivity is lower than that of the second salt used in Examples 1 and 3. Therefore, it is considered that the electrolyte solutions of Examples 1 and 3 are more preferable from the viewpoint of ion conductivity of the electrolyte solution. In the electrolyte solutions of Examples 1 to 3, although the ionic conductivity itself was lower than that of Comparative Example 1, the electrolyte solution exhibited good ionic conductivity. In particular, when the battery is used for a long time, the battery using the electrolyte solutions of Examples 1 to 3 is considered to be more effective in that an increase in battery resistance due to a decrease in the electrolyte solution can be further suppressed.

What is claimed is:

1. An electrolyte solution comprising a first salt, a second salt, and SO₂, wherein:
the first salt is a LiAl halide salt comprising at least LiAlCl₄; and
the second salt is an ionic liquid containing a sulfonyl group.

2. The electrolyte solution according to claim 1, wherein the ionic liquid has an ionic conductivity at 25° C. of 1.5 mS/cm or higher.

3. The electrolyte solution according to claim 1, wherein the ionic liquid has a viscosity at 25° C. of 200 mPa or less.

4. The electrolyte solution according to claim 1, wherein the ionic liquid contains at least one of bis(trifluoromethanesulfonyl)amide (TFSA) and bis(fluorosulfonyl)amide (FSA) an as anionic component.

5. A battery comprising:
a positive electrode active material layer;
a negative electrode active material layer; and
an electrolyte layer disposed between the positive electrode active material layer and the negative electrode active material layer, wherein
the positive electrode active material layer, the negative electrode active material layer, and the electrolyte layer contain the electrolyte solution according to claim 1.
